(19) United States
(12) Patent Application Publication
(10) Pub. No.: US 2025/0309363 A1
(43) Pub. Date: Oct. 2, 2025

(54) METHOD OF MANUFACTURING SOLID-STATE BATTERY

(71) Applicant: HONDA MOTOR CO., LTD., Tokyo (JP)

(72) Inventors: Kosei MIYATA, Saitama (JP); Akihiro YOSHIZAWA, Saitama (JP); Akihiro TAGUCHI, Saitama (JP)

(21) Appl. No.: 19/064,739

(22) Filed: Feb. 27, 2025

(30) Foreign Application Priority Data
Mar. 30, 2024 (JP) 2024-058322

(51) Int. Cl. H01M 10/0585

(52) U.S. Cl. CPC H01M 10/0585

(57) ABSTRACT

Provided is a method of manufacturing a solid-state battery. The solid-state battery includes an electrode laminate in which a negative electrode, an intermediate layer, an electrolyte layer, and a positive electrode are laminated sequentially. In the electrolyte layer, a first solid-state electrolyte layer, a gel electrolyte layer, and a second solid-state electrolyte layer are laminated sequentially in a laminating direction of the electrode laminate. The method of manufacturing the solid-state battery includes: a step 1A of preparing an intermediate layer-negative electrode laminate by pressing a material that constitutes the intermediate layer with the material being disposed on the negative electrode; a step 2A of preparing a first solid-state electrolyte layer-intermediate layer-negative electrode laminate by pressing a material that constitutes the first solid-state electrolyte layer with the material being disposed on a surface of the intermediate layer-negative electrode laminate where the intermediate layer is disposed.

This application is based on and claims the benefit of priority from Japanese Patent Application No. 2024-058322, filed on 30 Mar. 2024, the content of which is incorporated herein by reference.

### BACKGROUND OF THE INVENTION

### Field of the Invention

The present invention relates to a method of manufacturing a solid-state battery.

### Related Art

In recent years, research and development has been conducted on solid-state batteries that contribute to energy efficiency in order to ensure that more people have access to affordable, reliable, sustainable, and advanced energy.

As a solid-state battery, an all-solid-state battery is known, in which a solid-state electrolyte layer is arranged between a positive electrode and a negative electrode.

Japanese Unexamined Patent Application, Publication No. 2017-10816 describes a method of manufacturing an all-solid-state battery in which a positive electrode laminate, an intermediate solid-state electrolyte layer, and a negative electrode laminate are laminated in this order. Here, the positive electrode laminate has a positive electrode charge collector layer, a positive electrode active material layer, and a first solid-state electrolyte layer in this order, and the negative electrode laminate has a second solid-state electrolyte layer, a negative electrode active material layer, and a negative electrode charge collector layer containing copper, in this order. The method of manufacturing the all-solid-state battery includes a first pressing step of pressing the positive electrode laminate, a second pressing step of pressing the negative electrode laminate, and a third pressing step of pressing the positive electrode laminate, the intermediate solid-state electrolyte layer, and the negative electrode laminate. In this case, the pressing pressure of the first pressing step is higher than the pressing pressure of the third pressing step, and the pressing temperature of the first pressing step is greater than or equal to 150° C. and less than or equal to 175° C. The pressing pressure of the second pressing step is higher than the pressing pressure of the third pressing step, and the pressing temperature of the second pressing step is less than or equal to 125° C. Furthermore, the pressing temperature of the third pressing step is less than or equal to 125° C., and before being pressed in the third pressing process, the intermediate solid-state electrolyte layer is not pressed at a pressure exceeding the pressing pressure of the third pressing step.

Patent Document 1: Japanese Unexamined Patent Application, Publication No. 2017-10816

### SUMMARY OF THE INVENTION

However, in the method of manufacturing the all-solid-state battery described in Japanese Unexamined Patent Application, Publication No. 2017-10816, if the pressing pressure of the first pressing step and the pressing pressure of the second pressing step are high, the first solid-state electrolyte layer and the second solid-state electrolyte layer become dense and cracks occur in the electrodes during pressing in the third pressing step. On the contrary, if the pressing pressure of the first pressing step and the pressing pressure of the second pressing step are low, the first solid-state electrolyte layer and the second solid-state electrolyte layer do not become dense and the resistance of the all-solid-state battery increases.

An object of the present invention is to provide a method of manufacturing a solid-state battery that is able to lower the resistance of the solid-state battery and suppress the occurrence of cracks in the electrodes.
(1) A method of manufacturing a solid-state battery including an electrode laminate in which a negative electrode, an intermediate layer, an electrolyte layer, and a positive electrode are laminated sequentially, in which in the electrolyte layer, a first solid-state electrolyte layer, a gel electrolyte layer, and a second solid-state electrolyte layer are laminated sequentially in a laminating direction of the electrode laminate, the method of manufacturing the solid-state battery including: a step 1A of preparing an intermediate layer-negative electrode laminate by pressing a material that constitutes the intermediate layer with the material being disposed on the negative electrode; a step 2A of preparing a first solid-state electrolyte layer-intermediate layer-negative electrode laminate by pressing a material that constitutes the first solid-state electrolyte layer with the material being disposed on a surface of the intermediate layer-negative electrode laminate where the intermediate layer is disposed; a step 3 of preparing a second solid-state electrolyte layer-positive electrode laminate by pressing a material that constitutes the second solid-state electrolyte layer with the material being disposed on the positive electrode; and a step 4A of preparing the electrode laminate by pressing a material that constitutes the gel electrolyte layer with the material being disposed between a surface of the first solid-state electrolyte layer-intermediate layer-negative electrode laminate where the first solid-state electrolyte layer is disposed and a surface of the second solid-state electrolyte layer-positive electrode laminate where the second solid-state electrolyte layer is disposed.
(2) In the method of manufacturing the solid-state battery as described in (1), a pressing pressure in the step 2A is higher than a pressing pressure in the step 4A.
(3) In the method of manufacturing the solid-state battery as described in (2), the pressing pressure in the step 2A is greater than or equal to 600 MPa and less than or equal to 1000 MPa.
(4) In the method of manufacturing the solid-state battery as described in any one of (1) to (3), a pressing pressure in the step 3 is higher than a pressing pressure in the step 4A.
(5) In the method of manufacturing the solid-state battery as described in (4), the pressing pressure in the step 3 is greater than or equal to 800 MPa and less than or equal to 1200 MPa.
(6) A method of manufacturing a solid-state battery including an electrode laminate in which a negative electrode, an electrolyte layer, and a positive electrode are laminated sequentially, in which in the electrolyte layer, a first solid-state electrolyte layer, a gel electrolyte layer, and a second solid-state electrolyte layer are laminated sequentially in a laminating direction of the electrode laminate, the method of manufacturing the solid-state battery including: a step 2B of preparing a first solid-state electrolyte layer-negative electrode laminate by pressing a material that constitutes the first solid-state electrolyte layer with the material being disposed on the negative electrode; a step 3 of preparing a second solid-state electrolyte layer-positive electrode laminate by pressing a material that constitutes the second solid-state electrolyte layer with the material being disposed on the positive electrode; and a step 4B of preparing the electrode laminate by pressing a material that constitutes the gel electrolyte layer with the material being disposed between a surface of the first solid-state electrolyte layer-negative electrode laminate where the first solid-state electrolyte layer is disposed and a surface of the second solid-state electrolyte layer-positive electrode laminate where the second solid-state electrolyte layer is disposed.
(7) In the method of manufacturing the solid-state battery as described in any one of (1) to (6), the solid-state battery is a solid-state lithium metal battery.

The present invention can provide a method of manufacturing a solid-state battery that is able to lower the resistance of the solid-state battery and suppress the occurrence of cracks in electrodes.

### BRIEF DESCRIPTION OF THE DRAWINGS

FIG. 1 is a cross-sectional view of a solid-state battery according to one embodiment of the present invention;

FIG. 2 is a cross-sectional view for explaining a method of manufacturing an intermediate layer-negative electrode laminate;

FIG. 3 is a cross-sectional view for explaining a method of manufacturing a first solid-state electrolyte layer-intermediate layer-negative electrode laminate;

FIG. 4 is a cross-sectional view for explaining a method of manufacturing a second solid-state electrolyte layer-positive electrode laminate;

FIG. 5 is a cross-sectional view for explaining a method of manufacturing an electrode laminate;

FIG. 6 is a cross-sectional view for explaining a method of manufacturing a first solid-state electrolyte layer-negative electrode laminate; and

FIG. 7 is a cross-sectional view for explaining a method of manufacturing an electrode laminate.

### DETAILED DESCRIPTION OF THE INVENTION

An embodiment of the present invention will be described below with reference to the accompanying drawings.

### Solid-State Battery

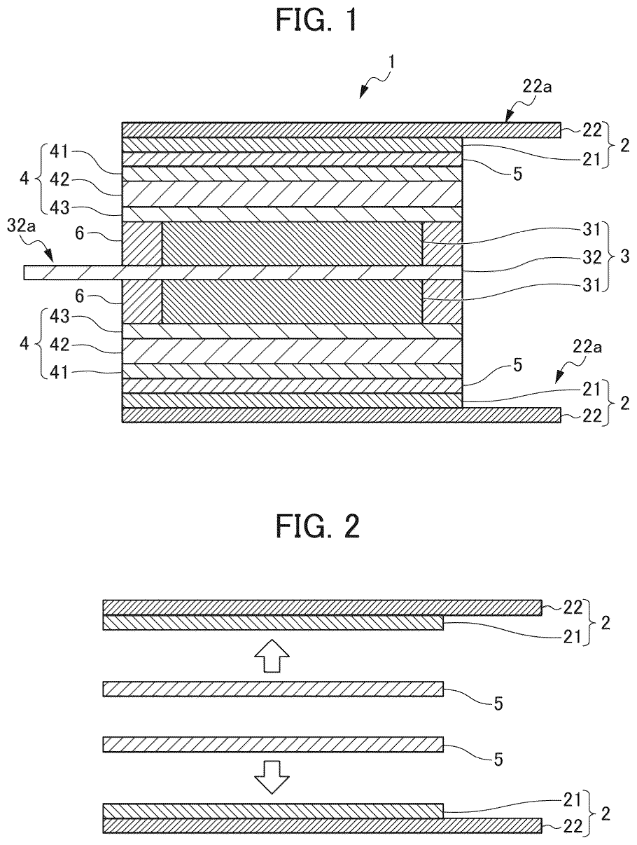

FIG. 1 shows a solid-state battery according to one embodiment of the present invention.

The solid-state battery 1 includes an electrode laminate in which a negative electrode 2, an intermediate layer 5, an electrolyte layer 4, a positive electrode 3, an electrolyte layer 4, an intermediate layer 5, and a negative electrode 2 are laminated sequentially. Here, the electrolyte layer 4 has a first solid-state electrolyte layer 41, a gel electrolyte layer 42, and a second solid-state electrolyte layer 43 laminated sequentially in the laminating direction of the electrode laminate. At this time, a portion of the gel electrolyte included in the gel electrolyte layer 42 may permeate the first solid-state electrolyte layer 41 and/or the second solid-state electrolyte layer 43.

In the negative electrode 2, a negative electrode composite layer 21 and a negative electrode charge collector 22 are laminated sequentially in the laminating direction of the electrode laminate. Here, a negative electrode charge collector tab 22a extends from one end of the negative electrode charge collector 22.

The positive electrode 3 has a positive electrode composite layer 31, a positive electrode charge collector 32, and a positive electrode composite layer 31 laminated sequentially in the laminating direction of the electrode laminate. When the positive electrode 3 is viewed from above with respect to the laminating direction of the electrode laminate, the outer circumference of the positive electrode composite layer 31 is inside the outer circumference of the positive electrode charge collector 32, and an insulating frame 6 is provided at the outer circumference of the positive electrode composite layer 31. When the insulating frame 6 is viewed from above with respect to the laminating direction of the electrode laminate, the outer circumference of the insulating frame 6 is at approximately the same position as the outer circumference of the positive electrode charge collector 32. Here, a positive electrode charge collector tab 32a extends from the end of the positive electrode charge collector 32 opposite to the end from which the negative electrode charge collector tab 22a extends.

Note that the solid-state battery 1 may be any battery that has an electrode laminate in which a negative electrode 2, an intermediate layer 5, an electrolyte layer 4, and a positive electrode 3 are laminated sequentially. For example, the solid-state battery 1 may have multiple positive electrodes 3. Alternatively, the solid-state battery 1 may have a single negative electrode 2, a single intermediate layer 5, and a single electrolyte layer 4. In this case, the positive electrode 3 has a positive electrode composite layer 31 and a positive electrode charge collector 32, which are laminated sequentially in the laminating direction of the electrode laminate. Further, the solid-state battery 1 does not necessarily include the intermediate layer 5.

### Method of Manufacturing Solid-State Battery

Next, a method of manufacturing a solid-state battery 1 will be explained with reference to FIGS. 2 to 5.

### Intermediate Layer-Negative Electrode Laminate

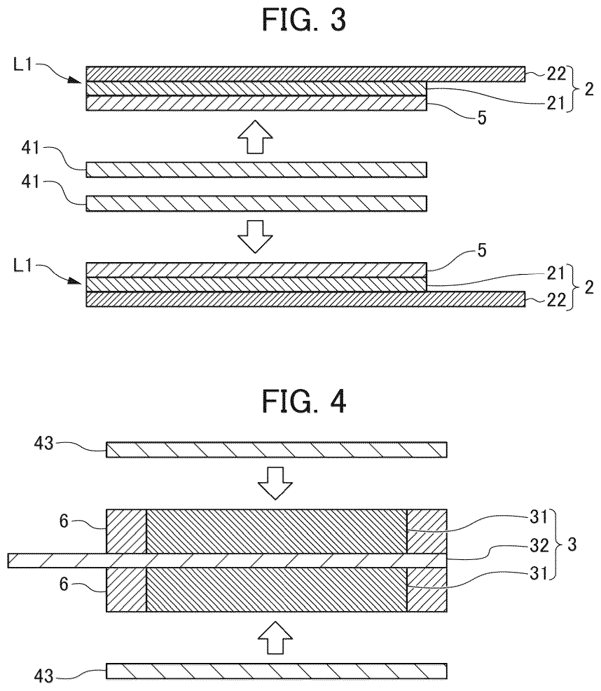

A laminate L1 of an intermediate layer-a negative electrode laminate is prepared by pressing a material that constitutes an intermediate layer 5 on the surface of the negative electrode 2 on which the negative electrode composite layer 21 is disposed (step 1A; see FIGS. 2 and 3). The method of disposing the material that constitutes the intermediate layer 5 on the surface of the negative electrode 2 on which the negative electrode composite layer 21 is disposed may be, but is not limited to, a method in which the intermediate layer 5 is transferred onto the negative electrode composite layer 21, with an intermediate layer transfer sheet. The intermediate layer transfer sheet is prepared, for example, by coating a support sheet with a slurry obtained by dispersing the material that constitutes the intermediate layer 5 in a solvent and then drying the slurry. The pressing pressure in the step 1A may be, but is not limited to, greater than or equal to 400 MPa and less than or equal to 1000 MPa. The pressing temperature in the step 1A may be, but is not limited to, greater than or equal to 25° C. and less than or equal to 150° C.

### First Solid-State Electrolyte Layer-Intermediate Layer-Negative Electrode laminate

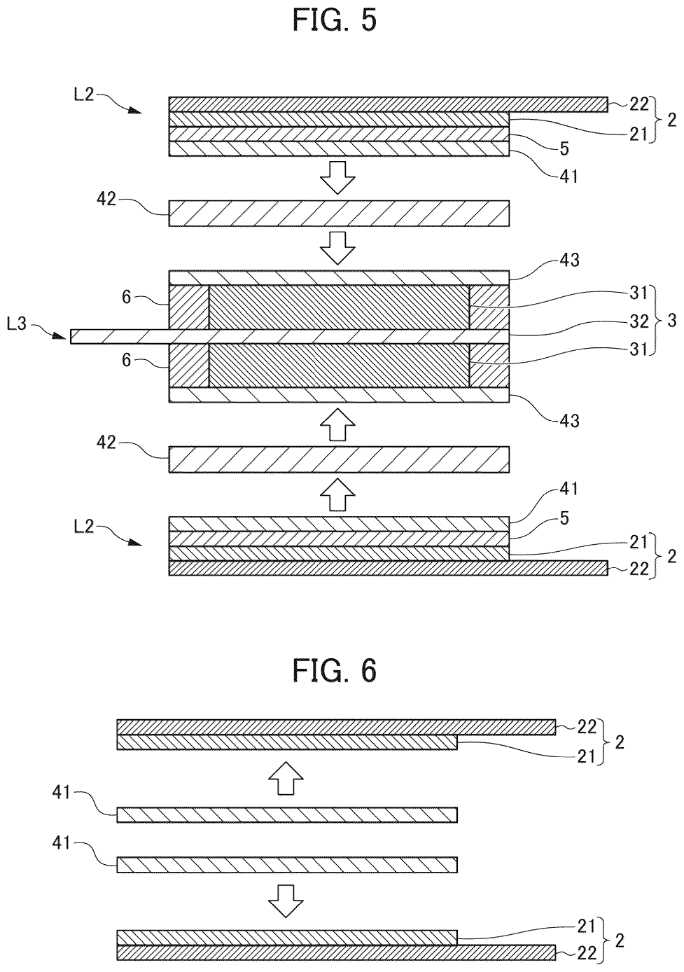

A first solid-state electrolyte layer-intermediate layer-negative electrode laminate L2 is prepared by pressing the material that constitutes the first solid-state electrolyte layer 41 with the material being disposed on the surface of the intermediate layer-negative electrode laminate L1 where the intermediate layer 5 is disposed (step 2A; see FIGS. 3 and 5). The method of disposing the material that constitutes the first solid-state electrolyte layer 41 on the surface of the intermediate layer-negative electrode laminate L1 on which the intermediate layer 5 is disposed may be, but is not limited to, a method in which the first solid-state electrolyte layer 41 is transferred onto the intermediate layer 5, with a first solid-state electrolyte layer transfer sheet. The first solid-state electrolyte layer transfer sheet is prepared, for example, by coating a support sheet with a slurry obtained by dispersing a solid-state electrolyte, which has a median diameter of less than or equal to 1 μm, in a solvent and then drying the slurry. At this time, the pressing pressure in the step 2A is preferably higher than the pressing pressure in the step 4A described below. This densifies the first solid-state electrolyte layer 41 and suppresses damage and deformation of each layer. The pressing pressure in the step 2A may be any pressure that can densify the first solid-state electrolyte layer 41, for example, greater than or equal to 600 MPa and less than or equal to 1000 MPa. The pressing temperature in the step 2A may be, but is not limited to, greater than or equal to 25° C. and less than or equal to 150° C.

The density of the first solid-state electrolyte layer 41 may be, but is not limited to, greater than or equal to 1.65 g/cm³ and less than or equal to 2.00 g/cm³. The porosity of the first solid-state electrolyte layer 41 may be, but is not limited to, greater than or equal to 18 and less than or equal to 7%. The thickness of the first solid-state electrolyte layer 41 may be, but is not limited to, greater than or equal to 1 μm and less than or equal to 7 μm.

### Second Solid-State Electrolyte Layer-Positive Electrode Laminate

A second solid-state electrolyte layer-positive electrode laminate L3 is prepared by pressing the material that constitutes the second solid-state electrolyte layer 43 with the material being disposed on both surfaces of a positive electrode 3 where the positive electrode composite layer 31 and the insulating frame 6 are disposed (step 3; see FIGS. 4 and 5). The method of disposing the material that constitutes the second solid-state electrolyte layer 43 on both surfaces of the positive electrode 3 where the positive electrode composite layer 31 and the insulating frame 6 are disposed may be, but is not limited to, a method in which the second solid-state electrolyte layer 43 is transferred onto the positive electrode composite layer 31 and the insulating frame 6, with a second solid-state electrolyte layer transfer sheet. The second solid-state electrolyte layer transfer sheet is prepared, for example, by coating a support sheet with a slurry obtained by dispersing a solid-state electrolyte, which has a median diameter of less than or equal to 1 μm, in a solvent and then drying the slurry. The pressing pressure in the step 3 is preferably higher than the pressing pressure in the step 4A described below. This densifies the second solid-state electrolyte layer 43 and suppresses damage and deformation of each layer. The pressing pressure in the step 3 may be any pressure that can densify the second solid-state electrolyte layer 43, for example, greater than or equal to 800 MPa and less than or equal to 1200 MPa. The pressing temperature in the step 3 may be, but is not limited to, greater than or equal to 25° C. and less than or equal to 1000° C.

The density of the second solid-state electrolyte layer 43 may be, but is not limited to, greater than or equal to 1.65 g/cm³ and less than or equal to 2.00 g/cm³. The porosity of the second solid-state electrolyte layer 43 may be, but is not limited to, greater than or equal to 1% and less than or equal to 7%. The thickness of the second solid-state electrolyte layer 43 may be, but is not limited to, greater than or equal to 1 μm and less than or equal to 7 μm.

### Electrode Laminate

An electrode laminate is prepared by pressing the material that constitutes the gel electrolyte layer 42 with the material being disposed between the surface of the first solid-state electrolyte layer-intermediate layer-negative electrode laminate L2 where the first solid-state electrolyte layer 41 is disposed and the surface of the second solid-state electrolyte layer-positive electrode laminate L3 where the second solid-state electrolyte layer 43 is disposed (step 4A; see FIG. 5). Consequently, even if the first solid-state electrolyte layer 41 and the second solid-state electrolyte layer 43 are densified, cracking of the negative electrode 2 and/or positive electrode 3 during pressing is suppressed. The method of disposing the material that constitutes the gel electrolyte layer 42 may be, but is not limited to, a method in which the gel electrolyte layer 42 is transferred onto the first solid-state electrolyte layer 41 or second solid-state electrolyte layer 43, with a gel electrolyte layer transfer sheet. The gel electrolyte layer transfer sheet is prepared, for example, by coating a support sheet with a slurry obtained by dispersing the material that constitutes the gel electrolyte layer 42 in a solvent and then drying the slurry. The pressing pressure in the step 4A may be any pressure that can integrate the electrolyte layer 4, for example, less than or equal to 500 MPa.

The machine used to manufacture the solid-state battery 1 may be, but is not limited to, a roll press machine or flat plate press machine.

A method of manufacturing the solid-state battery 1 without the intermediate layer 5 will now be described with reference to FIGS. 4, 6, and 7.

### First Solid-State Electrolyte Layer-Negative Electrode Laminate

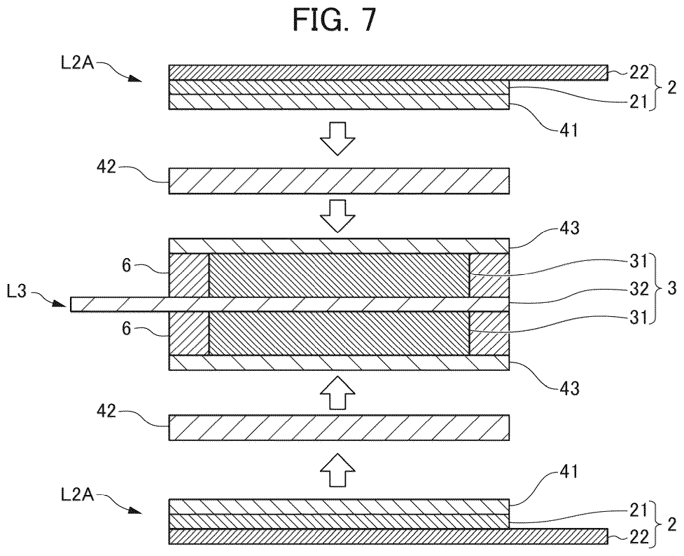

A first solid-state electrolyte layer-negative electrode laminate L2A is prepared by pressing the material that constitutes the first solid-state electrolyte layer 41 with the material being disposed on the surface of the negative electrode 2 where the negative electrode composite layer 21 is disposed (step 2B; see FIGS. 6 and 7). The method of disposing the material that constitutes the first solid-state electrolyte layer 41 on the surface of the negative electrode 2 where the negative electrode composite layer 21 is disposed may be, but is not limited to, a method in which the first solid-state electrolyte layer 41 is transferred onto the negative electrode composite layer 21, with a first solid-state electrolyte layer transfer sheet. The first solid-state electrolyte layer transfer sheet is prepared, for example, by coating a support sheet with a slurry obtained by dispersing a solid-state electrolyte, which has a median diameter of less than or equal to 1 μm, in a solvent and then drying the slurry. The pressing pressure may be any pressure that can densify the first solid-state electrolyte layer 41.

### Second Solid-State Electrolyte Layer-Positive Electrode Laminate

The second solid-state electrolyte layer-positive electrode laminate L3 is prepared by the method described above (step 3; see FIG. 4).

### Electrode Laminate

An electrode laminate is prepared by pressing the material that constitutes the gel electrolyte layer 42 with the material being disposed between the surface of the first solid-state electrolyte layer-negative electrode laminate L2A where the first solid-state electrolyte layer 41 is disposed and the surface of the second solid-state electrolyte layer-positive electrode laminate L3 where the second solid-state electrolyte layer 43 is disposed (step 4B; see FIG. 7). Consequently, even if the first solid-state electrolyte layer 41 and the second solid-state electrolyte layer 43 are densified, cracking of the negative electrode 2 and/or positive electrode 3 during pressing is suppressed. The method of disposing the material that constitutes the gel electrolyte layer 42 may be, but is not limited to, a method in which the gel electrolyte layer 42 is transferred onto the first solid-state electrolyte layer 41 or the second solid-state electrolyte layer 43, with a gel electrolyte layer transfer sheet. The gel electrolyte layer transfer sheet is prepared, for example, by coating a support sheet with a slurry obtained by dispersing the material that constitutes the gel electrolyte layer 42 in a solvent and then drying the slurry. The pressing pressure may be any pressure that can integrate the electrolyte layer 4.

Note that the machine used to manufacture the solid-state battery 1 without the intermediate layer 5 may be, but is not limited to, a roll press machine or flat plate press machine.

The solid-state battery may be, but is not limited to, a solid-state lithium metal battery. The following will describe the case where the solid-state battery 1 is a solid-state lithium metal battery.

The negative electrode composite layer 21 is a lithium metal layer. The negative electrode charge collector 22 may be, but is not limited to, a copper foil, for example.

The positive electrode composite layer 31 contains a positive electrode active material and may further contain a solid-state electrolyte, a conductivity aid, a binding agent, and the like. The positive electrode active material may be any material that can absorb and release lithium ions, for example, lithium nickel cobalt manganese composite oxide. The solid-state electrolyte may be any material that has lithium-ion conductivity, for example, an oxide-based electrolyte or sulfide-based electrolyte. The conductivity aid may be any material that has electron conductivity, for example, carbon black. The binding agent may be any material that can improve binding properties, for example, styrene butadiene rubber.

The positive electrode charge collector 32 may be, but is not limited to, an aluminum foil.

The first solid-state electrolyte layer 41 and the second solid-state electrolyte layer 43 contain a solid-state electrolyte. The solid-state electrolyte may be any material that has lithium-ion conductivity, for example, an inorganic solid-state electrolyte, such as an oxide-based electrolyte or sulfide-based electrolyte. Note that the first solid-state electrolyte layer 41 and the second solid-state electrolyte layer 43 may be composed of either the same solid-state electrolyte or different solid-state electrolytes.

The gel electrolyte layer 42 contains a matrix resin, an electrolyte, and a solvent. The matrix resin may be any material that can gel and integrate the electrolyte layer 4, for example, polyethylene oxide. The electrolyte may be any material that has lithium-ion conductivity, for example, a lithium salt. The solvent may be any material that can dissolve the electrolyte, for example, a carbonate solvent.

The intermediate layer 5 contains a metal that can be alloyed with lithium and amorphous carbon and may further contain a binding agent and the like. The metal that can be alloyed with lithium and amorphous carbon are preferably nanoparticles. Examples of the metal that can be alloyed with lithium include tin (Sn), silicon (Si), zinc (Zn), magnesium (Mg), gold (Au), platinum (Pt), palladium (Pd), silver (Ag), aluminum (Al), bismuth (Bi), and antimony (Sb). Examples of the amorphous carbon include carbon blacks such as acetylene black, furnace black, and Ketjen black, coke, and activated carbon. The amorphous carbon may be graphitizable carbon (soft carbon), non-graphitizable carbon (hard carbon), CNTs (carbon nanotubes), fullerenes, or graphene. The binding agent may be any agent that can improve binding properties, for example, polyvinylidene fluoride (PVDF).

The intermediate layer 5, which has the function of depositing lithium metal uniformly, stabilizes the interface between the intermediate layer 5 and the first solid-state electrolyte layer 41. If the solid-state battery 1 has the intermediate layer 5, the solid-state battery 1 may be an anode-free battery in which the lithium metal layer as a negative electrode composite layer 21 is not formed at the initial charge. In an anode-free battery, a lithium metal layer as a negative electrode composite layer 21 is formed after the first charging and discharging.

The thickness of the intermediate layer 5 may be, but is not limited to, greater than or equal to 4 μm and less than or equal to 10 μm.

The material that constitutes the insulating frame 6 may be, but is not limited to, an insulating oxide, such as alumina, a resin, such as polyvinylidene fluoride (PVDF), or a rubber, such as styrene butadiene rubber (SBR).

Although the embodiment of the present invention has been described above, the present invention is not limited to the above-mentioned embodiment, and the above-mentioned embodiment may be modified as appropriate without departing from the scope of the present invention. For example, the solid-state battery 1 may further include an exterior package (e.g., a laminating film) that encloses the electrode laminate.

### EXPLANATION OF REFERENCE NUMERALS

1 Solid-state battery
2 Negative electrode
21 Negative electrode composite layer
22 Negative electrode charge collector
22a Negative electrode charge collector tab
3 Positive electrode
31 Positive electrode composite layer
32 Positive electrode charge collector
32a Positive electrode charge collector tab
4 Electrolyte layer
41 First solid-state electrolyte layer
42 Gel electrolyte layer
43 Second solid-state electrolyte layer
5 Intermediate layer
6 Insulating frame
L1 Intermediate layer-negative electrode laminate
L2 First solid-state electrolyte layer-intermediate layer-negative electrode laminate
L2A First solid-state electrolyte layer-negative electrode laminate
L3 Second solid-state electrolyte layer-positive electrode laminate

What is claimed is:

1. A method of manufacturing a solid-state battery including an electrode laminate in which a negative electrode, an intermediate layer, an electrolyte layer, and a positive electrode are laminated sequentially, wherein
in the electrolyte layer, a first solid-state electrolyte layer, a gel electrolyte layer, and a second solid-state electrolyte layer are laminated sequentially in a laminating direction of the electrode laminate, the method of manufacturing the solid-state battery comprising:
a step 1A of preparing an intermediate layer-negative electrode laminate by pressing a material that constitutes the intermediate layer with the material being disposed on the negative electrode;
a step 2A of preparing a first solid-state electrolyte layer-intermediate layer-negative electrode laminate by pressing a material that constitutes the first solid-state electrolyte layer with the material being disposed on a surface of the intermediate layer-negative electrode laminate where the intermediate layer is disposed;
a step 3 of preparing a second solid-state electrolyte layer-positive electrode laminate by pressing a material that constitutes the second solid-state electrolyte layer with the material being disposed on the positive electrode; and
a step 4A of preparing the electrode laminate by pressing a material that constitutes the gel electrolyte layer with the material being disposed between a surface of the first solid-state electrolyte layer-intermediate layer-negative electrode laminate where the first solid-state electrolyte layer is disposed and a surface of the second solid-state electrolyte layer-positive electrode laminate where the second solid-state electrolyte layer is disposed.

2. The method of manufacturing the solid-state battery according to claim 1, wherein a pressing pressure in the step 2A is higher than a pressing pressure in the step 4A.

3. The method of manufacturing the solid-state battery according to claim 2, wherein the pressing pressure in the step 2A is greater than or equal to 600 MPa and less than or equal to 1000 MPa.

4. The method of manufacturing the solid-state battery according to claim 1, wherein a pressing pressure in the step 3 is higher than a pressing pressure in the step 4A.

5. The method of manufacturing the solid-state battery according to claim 4, wherein the pressing pressure in the step 3 is greater than or equal to 800 MPa and less than or equal to 1200 MPa.

6. A method of manufacturing a solid-state battery comprising an electrode laminate in which a negative electrode, an electrolyte layer, and a positive electrode are laminated sequentially, wherein
in the electrolyte layer, a first solid-state electrolyte layer, a gel electrolyte layer, and a second solid-state electrolyte layer are laminated sequentially in a laminating direction of the electrode laminate, the method of manufacturing the solid-state battery comprising:
a step 2B of preparing a first solid-state electrolyte layer-negative electrode laminate by pressing a material that constitutes the first solid-state electrolyte layer with the material being disposed on the negative electrode;
a step 3 of preparing a second solid-state electrolyte layer-positive electrode laminate by pressing a material that constitutes the second solid-state electrolyte layer with the material being disposed on the positive electrode; and
a step 4B of preparing the electrode laminate by pressing a material that constitutes the gel electrolyte layer with the material being disposed between a surface of the first solid-state electrolyte layer-negative electrode laminate where the first solid-state electrolyte layer is disposed and a surface of the second solid-state electrolyte layer-positive electrode laminate where the second solid-state electrolyte layer is disposed.

7. The method of manufacturing the solid-state battery according to claim 1, wherein the solid-state battery is a solid-state lithium metal battery.
